(19) United States
(12) Patent Application Publication
(10) Pub. No.: US 2026/0094882 A1
(43) Pub. Date: Apr. 2, 2026

(54) LITHIUM-ION BATTERY

(71) Applicant: ZHUHAI COSMX BATTERY CO., LTD., Zhuhai (CN)

(72) Inventors: Hongyu CUI, Zhuhai (CN); Fei HE, Zhuhai (CN)

(73) Assignee: ZHUHAI COSMX BATTERY CO., LTD., Zhuhai (CN)

(21) Appl. No.: 19/288,132

(22) Filed: Aug. 1, 2025

(30) Foreign Application Priority Data
Sep. 30, 2024 (CN) 202411386253.7

(51) Int. Cl. H01M 10/42; H01M 4/66; H01M 10/0525; H01M 50/494

(52) U.S. Cl. CPC H01M 10/4235; H01M 4/666; H01M 4/668; H01M 10/0525; H01M 50/494

(57) ABSTRACT

A lithium-ion battery includes a positive electrode plate, a negative electrode plate and a separator provided between the positive electrode plate and the negative electrode plate. The separator includes a base film; and the puncture force A of the separator, the thickness B of the base film, the puncture force C of the positive electrode current collector, the thickness D of the positive electrode current collector, the puncture force E of the negative electrode current collector and the thickness F of the negative electrode current collector satisfy a specific ratio, the contact between the positive electrode and the negative electrode under mechanical abuses can be reduced, thereby decreasing the formation of short circuit points, reducing heat generation, lowering the probability of thermal runaway, and improving the safety performance of the battery.

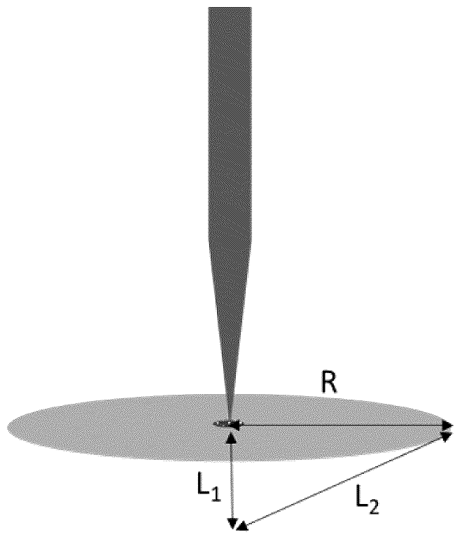

### CROSS-REFERENCE TO RELATED APPLICATIONS

The present disclosure claims priority to Chinese Patent Application No. 202411386253.7, filed on Sep. 30, 2024, which is hereby incorporated by reference in its entirety.

### TECHNICAL FIELD

The present disclosure belongs to the technical field of battery preparation, and in particular relates to a lithium-ion battery.

### BACKGROUND

Lithium-ion batteries have a high volumetric specific energy, a mass specific energy and cycling performance. With the development in the fields of portable electronic devices, electric vehicles, aerospace, and others, there is a growing demand for lithium-ion batteries. Electrical performance such as a high energy density and a high rate represents the development trends of lithium-ion batteries. As batteries are expected to meet increasingly stringent performance criteria, higher demands are also placed on the safety performance of the batteries.

The existing lithium-ion batteries are composed of a positive electrode, a negative electrode, and a separator provided between the positive and negative electrodes. During mechanical abuse testing (e.g., nail penetration and drop-weight impact), a short circuit occurs between the positive and negative electrodes, and the temperature at the short circuit points will rise sharply, which will result in the exothermic reaction of the internal materials, and as the exothermic reaction continues, it further results in reaction of the materials at other locations, leading to thermal runaway and safety concerns.

### SUMMARY

Therefore, the technical problem to be solved by the present disclosure is to provide a lithium-ion battery, so as to overcome the defects in the prior art that when the battery is subjected to mechanical abuse, a short circuit occurs between the positive and negative electrodes, resulting in a sharp temperature increase at the short circuit points, which will result in the continuous exothermic reaction of the internal materials, leading to thermal runaway and safety concerns, etc.

Thus, the present disclosure provides the following technical solution.

The present disclosure provides a lithium-ion battery. The lithium-ion battery includes a positive electrode plate, a negative electrode plate, and a separator provided between the positive electrode plate and the negative electrode plate, where the positive electrode plate includes a positive electrode current collector and a positive electrode active layer on a surface of at least one side of the positive electrode current collector; the negative electrode plate includes a negative electrode current collector and a negative electrode active layer on a surface of at least one side of the negative electrode current collector; the separator includes a base film; and the puncture force A of the separator, the thickness B of the base film, the puncture force C of the positive electrode current collector, the thickness D of the positive electrode current collector, the puncture force E of the negative electrode current collector and the thickness F of the negative electrode current collector satisfy relationship 1:

$$\frac{A}{B} > \frac{C}{D} + \frac{E}{F} relationship 1$$

where A is 1 N-8 N; B is 3 μm-16 μm; C is 1 N-10 N; D is 5 μm-20 μm; E is 1 N-10 N; and F is 3 μm-20 μm.

The technical solution of the disclosure has the following advantages.

The battery provided by the present disclosure, i.e., the lithium-ion battery includes a positive electrode plate, a negative electrode plate, and a separator provided between the positive electrode plate and the negative electrode plate, where the positive electrode plate includes a positive electrode current collector and a positive electrode active layer on a surface of at least one side of the positive electrode current collector; the negative electrode plate includes a negative electrode current collector and a negative electrode active layer on a surface of at least one side of the negative electrode current collector; the separator includes at least a base film; and the puncture force A of the separator, the thickness B of the base film, the puncture force C of the positive electrode current collector, the thickness D of the positive electrode current collector, the puncture force E of the negative electrode current collector and the thickness F of the negative electrode current collector satisfy relationship 1. When the puncture force of the separator, the thickness of the base film, the puncture force of the positive electrode current collector and thickness thereof, and the puncture force of the negative electrode current collector and thickness thereof in the battery satisfy a specific ratio, the contact between the current collector and the active material under mechanical abuses can be reduced, thereby decreasing the formation of short-circuit points, reducing heat generation, lowering the probability of thermal runaway and improving the pass rate in mechanical abuse tests. Further, the puncture force of the separator, the thickness of the base film, the puncture force of the positive electrode current collector and thickness thereof, and the puncture force of the negative electrode current collector and thickness thereof satisfy relationship 1 such that the low temperature performance of the battery can also be better balanced, that is the battery has good cycling performance, capacity retention and service life during charge and discharge under low temperature conditions (e.g. 0-10° C.).

### BRIEF DESCRIPTION OF THE DRAWINGS

In order to illustrate the technical solutions in the particular embodiments of the disclosure or in the prior art more clearly, the accompanying drawings to be used in the description of the particular embodiments or the prior art will be briefly introduced below; obviously, the accompanying drawings in the following description show some of the embodiments of the present application, and those of ordinary skill in the art may still obtain other drawings from these accompanying drawings without creative effort.

The accompanying FIGURE shows a schematic diagram of the deformation generated during the puncture force test of the separator according to the present disclosure.

### DETAILED DESCRIPTIONS OF THE EMBODIMENTS

The following examples are provided for a better understanding of the disclosure, are not limited to the preferred embodiments, and do not limit the content and scope of protection of the disclosure, and any product that is identical or similar to the disclosure, derived from the inspiration of the disclosure or by combining the disclosure with other features of the prior art, falls within the scope of protection of the disclosure.

In the description of the present disclosure, it should be noted that the orientation or positional relationships indicated by terms such as “inner” and “outer” are based on the orientation or positional relationships shown in the accompanying drawings and are merely for case of description of the present disclosure and simplification of the description, rather than indicating or implying that the devices or elements referred to must have a specific orientation or be constructed and operated in a described orientation, and therefore cannot be construed as limiting the present disclosure. In addition, the terms “first”, “second”, and “third” are used for descriptive purposes only, and cannot be construed as indicating or implying relative importance.

The examples in which experimental steps or conditions are not specified are based on the operations of conventional experimental steps or conditions described in documents in the art. The reagents or instruments used without indicating a manufacturer are all commercially available conventional reagent products.

In addition, the technical features referred to in different embodiments of the disclosure described below can be combined with each other as long as they do not conflict with each other.

The present disclosure provides a lithium-ion battery, which has reduced formation of short-circuit points under mechanical abuse conditions, thereby lowering the probability of thermal runaway, improving the pass rate in mechanical abuse tests, and improving the safety performance of the battery. The lithium-ion battery still has good electrical performance such as cycling performance and capacity retention during charging and discharging at low temperatures, and has a long service life, and balanced safety performance and the low temperature electrical performance. The technical solutions used in the present disclosure are described herebelow.

In the first aspect, the present disclosure provides a lithium-ion battery. The lithium-ion battery includes a positive electrode plate, a negative electrode plate, and a separator provided between the positive electrode plate and the negative electrode plate, where the positive electrode plate includes a positive electrode current collector and a positive electrode active layer on a surface of at least one side of the positive electrode current collector; the negative electrode plate includes a negative electrode current collector and a negative electrode active layer on a surface of at least one side of the negative electrode current collector; the separator includes a base film; and the puncture force A of the separator, the thickness B of the base film, the puncture force C of the positive electrode current collector, the thickness D of the positive electrode current collector, the puncture force E of the negative electrode current collector and the thickness F of the negative electrode current collector satisfy relationship 1:

$$\frac{A}{B} > \frac{C}{D} + \frac{E}{F} relationship 1$$

where the puncture force A of the separator is 1 N-8 N; the thickness B of the base film is 3 μm-16 μm; the puncture force C of the positive electrode current collector is 1 N-10 N; the thickness D of the positive electrode current collector is 5 μm-20 μm; the puncture force E of the negative electrode current collector is 1 N-10 N; and the thickness F of the negative electrode current collector is 3 μm-20 μm.

Optionally, the puncture force C of the positive electrode current collector is 1 N-2.5 N; and the puncture force E of the negative electrode current collector is 1 N-2.5 N.

It can be understood by those skilled in the art that during mechanical abuse testing of batteries, a short circuit is prone to occur between the positive electrode and the negative electrode, and the temperature at the short circuit points will rise sharply, which will result in the exothermic reaction of the internal materials, and as the exothermic reaction continues, it further results in reaction of the materials at other locations, leading to thermal runaway and potential safety hazards. In order to solve the above problems, the present inventors have found through research that when the puncture force of the separator, the thickness of the base film, the puncture force of the positive electrode current collector and thickness thereof, and the puncture force of the negative electrode current collector and thickness thereof satisfy a specific ratio, the contact between the current collector and the active material under mechanical abuses can be reduced, thereby decreasing the formation of short-circuit points, reducing heat generation, lowering the probability of thermal runaway and improving the pass rate in mechanical abuse tests; in particular, the contacts between the positive electrode current collector and the negative electrode active material are reduced. Further, the puncture force of the separator, the thickness of the base film, the puncture force of the positive electrode current collector and thickness thereof, and the puncture force of the negative electrode current collector and thickness thereof satisfy relationship 1 such that the low temperature performance of the battery can also be better balanced, that is the battery has good cycling performance, capacity retention and service life during charge and discharge under low temperature conditions (e.g. 0-10° C.).

The puncture force A of the separator is 1 N-8 N; the thickness B of the base film is 3 μm-16 μm; the puncture force C of the positive electrode current collector is 1 N-10 N; the thickness D of the positive electrode current collector is 5 μm-20 μm; the puncture force E of the negative electrode current collector is 1 N-10 N; and the thickness F of the negative electrode current collector is 3-20 μm. By controlling the above parameters within defined ranges and satisfying relationship 1, the formation of thermal runaway, short circuit, etc., can be reduced.

As an example, A is 1 N, 2 N, 3 N, 4 N, 5 N, 6 N, 7 N, 8 N or in a range of any two of the foregoing values. B is 3 μm, 4 μm, 5 μm, 6 μm, 7 μm, 8 μm, 9 μm, 10 μm, 11 μm, 12 μm, 13 μm, 14 μm, 15 μm, 16 μm or in a range of any two of the foregoing values. C is 1 N, 2 N, 3 N, 4 N, 5 N, 6 N, 7 N, 8 N, 9 N, 10 N or in a range of any two of the foregoing values. D is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm or in a range of any two of the foregoing values. E is 1 N, 2 N, 3 N, 4 N, 5 N, 6 N, 7 N, 8 N, 9 N, 10 N or in a range of any two of the foregoing values. F is 3 μm, 4 μm, 5 μm, 6 μm, 7 μm, 8 μm, 9 μm, 10μ, 11μ m, 12 μm, 13 μm, 14 μm, 15 μm, 16 μm, 17 μm, 18 μm, 19 μm, 20 μm or in a range of any two of the foregoing values.

It should be noted that: the puncture force of the separator, positive electrode current collector or negative electrode current collector according to the present disclosure refers to the maximum force applied to the needle when it punctures the separator or current collector. The puncture force of the separator and the puncture force of the current collector are determined according to the well-known methods in the art. Here is listed an example: testing the puncture force by using a universal tensile testing machine, including: mounting a sample with a length×width≥80 mm×80 mm on the fixture, setting the puncture speed, moving the needle downward, and determining the puncture force, based on the data from the testing machine, which is the maximum force applied to the needle during complete penetration of the sample. In an optional embodiment, the deformation G generated during the puncture force test of the separator and the thickness H of the positive electrode plate satisfy relationship 2:

$$G > H relationship 2$$

where L₁ is 1.5 mm-4.5 mm; and H is 50 μm-150 μm;
preferably, H is 60 μm-110 μm.

In an optional embodiment, the deformation G generated during the puncture force test of the separator and the thickness I of the negative electrode plate satisfy relationship 3:

$$G > I relationship 3$$

where L₁ is 1.5 mm-4.5 mm; and I is 50 μm-180 μm;
preferably, I is 50 μm-100 μm.

It can be understood that according to the present disclosure, the deformation generated during the puncture force test of the separator and the thickness of the positive and negative electrode current collectors satisfy relationship 2 and/or relationship 3 such that the contact between the current collector and the active material can be further reduced, thereby decreasing the formation of short-circuit points, further lowering the probability of thermal runaway, and increasing the pass rate in the battery mechanical abuse test. As an example, L₁ is 1.5 μm, 1.8 μm, 2.1 μm, 2.4 μm, 2.7 μm, 3 μm, 3.3 μm, 3.6 μm, 3.9 μm, 4.2 μm, 4.5 μm or in a range of any two of the foregoing values; His 50 μm, 60 μm, 70 μm, 80 μm, 90 μm, 100 μm, 110 μm, 120 μm, 130 μm, 140 μm, 150 μm or in a range of any two of the foregoing values; I is 50 μm, 60 μm, 70 μm, 80 μm, 90 μm, 100 μm, 110 μm, 120 μm, 130 μm, 140 μm, 150 μm, 160 μm, 170 μm, 180 μm or in a range of any two of the foregoing values. It can also be understood that the thickness H of the positive electrode plate is the overall thickness of the positive electrode plate; and the thickness I of the negative electrode plate is the overall thickness of the negative electrode plate.

It should be noted that the deformation generated during the puncture force test of the separator is calculated as follows: the displacement traveled by the needle during the puncturing process from the point at which the needle initially contacts the separator to the point where the separator is punctured is denoted as L₁, the distance from the point at which the needle initially contacts the separator to the edge of the fixture is denoted as R, and according to the Pythagorean theorem, L₂ is calculated, that is

$${L}_{2} = \sqrt{{L}_{1}^{2} + {R}^{2}} ,$$

the deformation G=L₂−R. The schematic representation of the puncture process and associated calculation are shown in the accompanying FIGURE.

In an optional embodiment, the positive electrode current collector is provided on at least one surface with a first coating and a positive electrode active layer. The first coating is provided between the positive electrode current collector and the positive electrode active layer, and the first coating includes a non-conductive organic polymer. The non-conductive organic polymer can reduce the conductivity of the positive electrode plate, increase the area resistance, resulting in a less short-circuit current and less heat generated during short-circuiting, which is beneficial to pass the safety performance test. It can be understood that the non-conductive organic polymer derives from the binder in the coating, where as the binder a non-conductive organic polymer is selected.

Preferably, the non-conductive organic polymer is present as polymer particles.

In an optional embodiment, the polymer particles include at least one of polyvinylidene fluoride (PVDF), acrylic acid-modified PVDF, polyacrylate polymers, polyimide, styrene-butadiene rubbers and styrene-acrylic rubbers.

In an optional embodiment, the area resistance of the first coating is 1 m²-1000 mΩ;

In an optional embodiment, the area resistance of the first coating is 1 mΩ-100 mΩ.

In an optional embodiment, the ionic conductivity J of the separator and the area resistance K of the first coating layer satisfy relationship 4:

$$0.5 \% \leq \frac{J}{K} \times 100 \% \leq 10 \% \qquad relationship 4$$

where J is 0.1-5 mS/cm (for example, 0.1-2 mS/cm); and K is 1 mΩ-100 mΩ;

Preferably, the ionic conductivity J of the separator and the area resistance K of the first coating satisfy relationship 5:

$$4 \% \leq \frac{J}{K} \times 100 \% \leq 6 \% . \qquad relationship 5$$

The present inventors found through research that increasing the area resistance of the first coating results in an increase in the impedance of the positive electrode plate, resulting in a less short-circuit current and less heat generated during short-circuiting, which is beneficial to pass the safety performance test while causing degradation in high-rate performance. Therefore, the present disclosure can achieve the compensation for the defect of poor conductivity caused by the first coating by allowing the ionic conductivity of the separator to satisfy 0.1 to 5 mS/cm, and balance of the electrical performance and safety performance while ensuring the electrical performance of the battery. As an example, Jis 0.1 mS/cm, 0.3 mS/cm, 0.5 mS/cm, 0.7 mS/cm, 0.9 mS/cm, 1.1 mS/cm, 1.3 mS/cm, 1.5 mS/cm, 1.7 mS/cm, 1.9 mS/cm, 2 mS/cm, 2.1 mS/cm, 2.3 mS/cm, 2.5 mS/cm, 2.7 mS/cm, 2.9 mS/cm, 3 mS/cm, 3.1 mS/cm, 3.3 mS/cm, 3.5 mS/cm, 3.7 mS/cm, 3.9 mS/cm, 4 mS/cm, 4.1 mS/cm, 4.3 mS/cm, 4.5 mS/cm, 4.7 mS/cm, 5 mS/cm or in a range of any two of the foregoing values. K is 1 mΩ, 10 mΩ, 20 mΩ, 30 mΩ, 40 mΩ, 50 mΩ, 60 m (2, 70 mΩ, 80 mΩ, 90 mΩ, 100 mΩ or in a range of any two of the foregoing values. It should be noted that the ionic conductivity of the separator is measured according to conventional methods in the art.

In an optional embodiment, the first coating includes a non-conductive organic polymer, which can increase the area resistance and has a large impedance, resulting in a less short-circuit current and less heat generated during short-circuiting, which is beneficial to pass the safety performance test,

In an optional embodiment, the thickness M of the first coating, the thickness N of the separator and the thickness F of the negative electrode current collector satisfy relationship 6:

$$\frac{M + N}{F} > 1 \qquad relationship 6$$

where M is 0.1 μm-5 μm; and Nis 3 μm-22 μm;
preferably, M is 2 μm-4 μm.

The present inventors found through research that by designing the thickness of the negative electrode current collector, the thickness of the separator, and the thickness of the first coating in the positive electrode plate to satisfy a specific requirement, the pass rate in the battery mechanical abuse test can be further improved. When the negative electrode current collector is relatively thick, it needs to be matched with either a thicker separator or a thicker first coating to reduce the short-circuit points generated during mechanical abuse testing. Designing the thickness of the negative electrode current collector, the thickness of the separator and the thickness of the first coating to satisfy relationship 6 can reduce the formation of short-circuit points and further improve the pass rate in battery mechanical abuse testing. As an example, Mis 0.1 μm, 0.4 μm, 0.7 μm, 1.0 μm, 1.2 μm, 1.5 μm, 1.8 μm, 2.1 μm, 2.4 μm, 2.7 μm, 3 μm, 3.3 μm, 3.6 μm, 3.9 μm, 4.2 μm, 4.5 μm, 5 μm or in a range of any two of the foregoing values. Nis 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm or in a range of any two of the foregoing values. It can be understood that the thickness of the first coating of the present disclosure is 0.1 μm-5 μm, allowing the battery to have balanced performance and energy density.

It should be noted that the first coating may be provided on one or both sides of the positive electrode current collector; the first coating is of a one-layer, two-layer or multi-layer structure. As an example, the first coating is of one of a single-layer structure, a two-layer structure, a three-layer structure, etc. When it is of a two-layer or multi-layer structure, the components of each coating may be the same or different. In one embodiment, the first coating includes at least two layers with different compositions. It can be understood that the thickness of the first coating refers to the thickness of the coating located on the same side of the positive electrode current collector. When the first coating is of a two-layer or multilayer structure, the preparation method therefor is a common one in the art, for example by forming a multilayer structure by means of multiple coating.

In an optional embodiment, the components of the first coating include an inorganic filler, a binder, and a conductive agent. The inorganic filler is coated with a conductive layer. The inorganic filler coated with the conductive layer, the binder and the conductive agent have a mass ratio of (60-98):(2-40):(0-5). It should be noted that a ratio of a conductive agent of 0 refers to a technical solution where the composition of the first coating does not contain a conductive agent. It can be understood that the inorganic fillers have high mechanical strength, stability and heat resistance, and when the battery is subjected to mechanical abuses (e.g., nail penetration and crush), the inorganic fillers can protect well the positive electrode current collector from being exposed, reduce the contact between the positive electrode current collector and the negative electrode active material, lower the probability of short circuits and enhancing the safety performance of the battery. The inorganic fillers are coated with a conductive layer on the outer surface, which facilitates achieving excellent safety and cycling performance of the battery.

In an optional embodiment, the inorganic filler is selected from at least one of aluminum oxide, magnesium oxide, titanium oxide, zinc oxide, silicon oxide, bochmite, cobalt oxide, iron phosphate, lithium iron phosphate, lithium nickel cobalt manganese oxide and lithium manganese iron phosphate. The resistivity of the inorganic filler coated with the conductive layer is 1 Ω·cm-100 Ω·cm, and the resistivity of the inorganic filler is measured according to the well-known methods in the art. By way of example, the inorganic filler coated with the conductive layer has a resistivity of 1 Ω·cm, 3 Ω·cm, 5 Ω·cm, 7 Ω·cm, 9 Ω·cm, 10 Ω·cm, or in a range of any two of the foregoing values. The inorganic filler coated with the conductive layer has an average particle size of 0.05 μm to 5 μm, preferably 100 nm to 600 nm. By way of example, the average particle size of the inorganic filler is 0.05 μm, 0.1 μm, 0.2 μm, 0.3 μm, 0.4 μm, 0.5 μm, 0.6 μm, 0.7 μm, 0.8 μm, 0.9 μm, 1.0 μm, 1.5 μm, 2.0 μm, 2.5 μm, 3.0 μm, 3.5 μm, 4.0 μm, 4.5 μm, 5.0 μm or in a range of any two of the foregoing values.

For those skilled in the art, conductive agents are common raw materials in the art, including, for example, one or more of conductive carbon black (SP), acetylene black, Ketjen black, conductive graphite, conductive carbon fibers, carbon nanotubes, metal powder and carbon fibers. The binders are common raw materials in the art. For example, the binders include water-based binders and/or oil-based binders. The water-based binders include one or more of polyacrylic acid (PAA), polyacrylate, styrene-butadiene rubbers (SBR), carboxymethyl cellulose (CMC), and polyacrylonitrile (PAN). The oil-based binders include one or more of polyvinylidene fluoride (PVDF), polyvinyl alcohols (PVA), polytetrafluoroethylene (PTFE), polyolefins (e.g., homopolymers or copolymers of ethylene, propylene, etc.), fluorinated rubbers, polyimides (PI) and perfluorosulfonic acid ionomers (Nafion).

In an optional embodiment, the material of the conductive layer includes at least one of ATO, FTO, ITO, and a carbon material. The ATO is tin dioxide doped with antimony elements, FTO is tin dioxide doped with a fluorine element, and ITO is indium oxide doped with a tin element, where the doping amount of the antimony element in ATO is ≤30%, the doping amount of the fluorine element in FTO is ≤10%, and the doping amount of the tin element in ITO is ≤30%. It can be understood that the above conductive layer materials have a good coating effect on inorganic fillers, and the conductive layer is formed on the outer surface of the inorganic filler, which reduces the heat transfer rate and improves the safety performance of the battery.

In an optional embodiment, the mass content of the conductive layer is 2 wt %-40 wt %, preferably 10 wt %-30 wt %, based on the total mass of the inorganic filler coated with the conductive layer, which can allow the battery to have balanced safety performance and conductivity. As an example, the mass content of the conductive coating layer in the inorganic filler is 2 wt %, 6 wt %, 10 wt %, 15 wt %, 20 wt %, 25 wt %, 30 wt %, 35 wt %, 40 wt %, or in a range of any two of the foregoing values.

In an optional embodiment, the area resistance of the first coating is 1 mΩ-1000 mΩ, preferably 1 mΩ-100 mΩ. As an example, the area resistance of the first coating is 1 mΩ, 5 mΩ, 10 mΩ, 15 m (2, 20 mΩ, 30 mΩ, 40 mΩ, 50 mΩ, 60 mΩ, 70 mΩ, 80 mΩ, 90 mΩ, 100 mΩ, 200 mΩ, 300 mΩ, 400 mΩ, 500 mΩ, 600 mΩ, 700 mΩ, 800 mΩ, 900 mΩ, 1000 mΩ or in a range of any two of the foregoing values. It should be noted that the area resistance of the first coating is measured in accordance with the well-known methods in the art. Here, one testing method is listed: testing the area resistance of the coating using a bulk resistance meter.

In an optional embodiment, the first coating has an areal density of 0.1 mg/cm²-1.5 mg/cm², preferably 0.5 mg/cm²-1.2 mg/cm². As an example, the areal density of the first coating is 0.1 mg/cm², 0.3 mg/cm², 0.6 mg/cm², 0.9 mg/cm², 1.2 mg/cm², 1.5 mg/cm² or in a range of any two of the foregoing values. It can be understood that the areal density of the first coating will affect the thickness of the first coating. An areal density of the first coating ranging from 0.1 mg/cm² to 1.5 mg/cm² can allow the thickness of the first coating to satisfy 0.5 μm-5 μm. It is understood that the areal density is the mass per unit area.

In an optional embodiment, the peel force between the first coating and the positive electrode current collector is 20 N/m-1000 N/m, preferably 100 N/m-500 N/m. As an example, the peel force between the first coating and the positive electrode current collector is 20 N/m, 50 N/m, 80 N/m, 110 N/m, 140 N/m, 170 N/m, 200 N/m, 230 N/m, 260 N/m, 290 N/m, 320 N/m, 350 N/m, 380 N/m, 410 N/m, 440 N/m, 470 N/m, 500 N/m, 600 N/m, 700 N/m, 800 N/m, 900 N/m, 1000 N/m or in a range of any two of the foregoing values. It should be noted that the peel force is measured according to the well-known methods in the art. For example, a positive electrode current collector with a length of 100 mm and a width of 15 mm that has been coated with the first coating is cut as the sample to be tested; the positive electrode current collector is secured between the upper fixture and the lower fixture of the universal tensile testing machine; and the sample is peeled at 180° with a test speed of 100 mm/min and a test displacement distance of 80 mm. The peel force is determined by converting the parameters measured by the tensile testing machine.

In an optional embodiment, the separator has a tensile strength of 1200-7000 kgf/cm² in the transverse direction (TD direction), and a tensile strength of 1200 to 7000 kgf/cm² in the machine direction (MD direction); and/or,

the separator has an elongation at break >30% in the TD direction, and an elongation at break >30% in the MD direction; and/or, the separator has a puncture strength of >120 gf.

As an example, the tensile strength of the separator in the TD direction is 1200 kgf/cm², 1500 kgf/cm², 2000 kgf/cm², 2500 kgf/cm², 3000 kgf/cm², 3500 kgf/cm², 4000 kgf/cm², 4500 kgf/cm², 5000 kgf/cm², 5500 kgf/cm², 6000 kgf/cm², 6500 kgf/cm², 7000 kgf/cm² or in a range of any two of the foregoing values. The tensile strength of the separator in the MD direction is 1200 kgf/cm², 1500 kgf/cm², 2000 kgf/cm², 2500 kgf/cm², 3000 kgf/cm², 3500 kgf/cm², 4000 kgf/cm², 4500 kgf/cm², 5000 kgf/cm², 5500 kgf/cm², 6000 kgf/cm², 6500 kgf/cm², 7000 kgf/cm² or in a range of any two of the foregoing values. The elongation at break of the separator in the TD direction is 31%, 35%, 40%, 45%, 50%, 200% or in a range of any two of the foregoing values. The elongation at break of the separator in the MD direction is 31%, 35%, 40%, 45%, 50%, 60%, 70%, 80%, 100%, 130%, 170%, 200% or in a range of any two of the foregoing values. The puncture strength of the separator is 125 gf, 130 gf, 135 gf, 140 gf, 145 gf, 150 gf, 200 gf, 300 gf, 400 gf, 500 gf, 600 gf or in a range of any two of the foregoing values.

In an optional embodiment, the separator has a thermal shrinkage of <10% in the TD (at 105° C. for 1 h) direction and <10% in the MD (at 105° C. for 1 h) direction; a coefficient of friction of 0.2-0.7; a meltdown temperature >150° C.; a shutdown temperature <147° C.; a porosity of 38%-68%; and an air permeability of 80-400 s/100 cc.

It should be noted that elongation at break, tensile strength, thermal shrinkage, puncture strength, coefficient of friction, meltdown temperature, shutdown temperature, porosity, air permeability, etc. of the separator are measured according to well known methods in the art. The puncture strength and the puncture force have the same characteristic meaning. A puncture force of 1 N is approximately equivalent to a puncture strength of 102 gf, and they are obtained using identical testing methods.

The tensile strength of the separator is defined as the maximum stress value required to cause failure under tensile stress, expressed in kgf/cm². The elongation at break is defined as the ratio of the increase in the gauge length of a material at the point of failure under a tensile load to the initial gauge length, in %. The elongation at break and tensile strength are determined with reference to the provisions of GB/T1040.3-2006, using a specimen with a width of (15±0.1) mm, a tensile testing machine with an initial distance (100±5) mm between the fixtures, at a test speed of (250±10) mm/min.

Thermal shrinkage: firstly, the test sample of the separator to be cut is clamped flat between A4 paper sheets, and die-cut in a punch die to a size of 100×100 mm; second, the length is measured using a 2.5 D microscope, with the transverse and longitudinal lengths recorded; the separator sample clamped between the A4 paper sheets was then placed in an oven and baked at 105° C. for 1 h, and after the baking, the sample is cooled for 10 min before immediately measuring the separator with a microscope and the thermal shrinkage is calculated. The calculation formula of the separator shrinkage is:

$$Transverse ( TD ) = ( width before baking - width after baking ) / Width before baking \times 100 \%$$

$$Longitudinal ( MD ) = ( Length before baking - Length after baking ) / Length before baking \times 100 \% .$$

Porosity: firstly, the separator is stacked in 6 layers, and flatten and compress firmly to remove the air from the separator. The stacked separator is cut according to the cutting template and the cut sample is measured to obtain the sample area S. The thickness of the sample is then measured 10 times, and the average value is calculated as B. The separator is weighed 3 times using an electronic balance, and the average value M is obtained. The porosity of the separator is calculated according to the following formula:

$$Porosity C ( \% ) = [ ( density of separator raw material \times S \times B - M ) \div ( density of separator raw material \times S \times B ) ] \times 100 \% .$$

Air permeability: the air permeability of the separator is tested by using a separator Gurley densometer.

Coefficient of friction: using a kinetic coefficient of friction tester, the testing method is as follows: a current collector with a length of 100 mm and a width of 80 mm is cut out, placed on a smooth plane, a 75 mm×75 mm separator is mounted to a 65 mm×65 mm slider, and the slider is moved forward at a constant speed of 100 mm/min, to measure the friction force, and the kinetic coefficient of friction is obtained.

Meltdown temperature and shutdown temperature: firstly, a battery for testing needs to be constructed, which will be used for subsequent heating and resistance measurement. Secondly, the test battery is placed in an environment with a controllable temperature, the temperature is gradually increased from 30° C. to 200° C., and during the heating process, the temperature of the test battery and the corresponding resistance value thereof need to be recorded every 5 seconds. Finally, the temperature-resistance curve of the test battery is plotted based on the recorded data. By calculating the change in resistance value at 5-second intervals, the shutdown temperature and the meltdown temperature are determined based on when the resistance increases or decreases by more than 50 Ω for the first time, respectively. That is, when the resistance value increases by more than 50Ω for the first time, it is recorded as the shutdown temperature; when the resistance value decreases by more than 50Ω for the first time, it is recorded as the meltdown temperature.

In an optional embodiment, the base film has a thickness B of 3 μm-16 μm; and/or, a porosity of 25-50%; and/or, an air permeability of 50 s/100 cc-250 s/100 cc; and/or, a pore size distribution of 20-90 nm. By way of example, the thickness of the base film is 3 μm, 6 μm, 9 μm, 12 μm, 16 μm or in a range of any two of the foregoing values; the porosity is 25%, 30%, 35%, 40%, 45%, 50%, or in a range of any two of the foregoing values; the air permeability is 50 s/100 cc, 80 s/100 cc, 110 s/100 cc, 140 s/100 cc, 170 s/100 cc, 200 s/100 cc, 250 s/100 cc or in a range of any two of the foregoing values; the pore size distribution is 20 nm, 30 nm, 40 nm, 50 nm, 60 nm, 70 nm, 80 nm, 90 nm or in a range of any two of the foregoing values.

It should be noted that the material of the base film is selected from well-known raw materials in the art and is not limited thereto. By way of example, the material of the base film includes at least one of polyethylene, polypropylene, polyethylene terephthalate, polyphenylene sulfide, polyimide, polystyrene, polytetrafluoroethylene, polymethyl methacrylate, polyvinylidene fluoride, polyvinylidene fluoride-hexafluoropropylene, cellulose, etc.

In an optional embodiment, the separator further includes a coating located on at least one surface of the base film. The coating includes at least one layer structure of an adhesive-coated layer and a ceramic layer; the ceramic layer is provided at least on one surface of the base film, the thickness of the ceramic layer is 0.3 μm-4 μm. It should be noted that the thickness of the ceramic layer refers to the total thickness on one side of the separator. As an example, the thickness of the ceramic layer is 0.3 μm, 0.9 μm, 1.5 μm, 2.1 μm, 2.7 μm, 3.3 μm, 4.0 μm or in a range of any two of the foregoing values. It should be understood that the ceramic layer may be of a one-layer or multi-layer structure. When the ceramic layer is of a multi-layer structure, the components of each layer are the same or different, and a multiple coating method is used.

In an optional embodiment, the peel force between the ceramic layer and the base film is higher than 10 N/m. By way of example, the peel force between the ceramic layer and the substrate layer is 10.5 N/m, 11 N/m, 13 N/m, 15 N/m, 17 N/m, 19 N/m, 21 N/m, 23 N/m, 25 N/m, 30 N/m, 45 N/m, 70 N/m or in a range of any two of the foregoing values.

In an optional embodiment, the components of the ceramic layer include inorganic particles and a binder. Optionally, the mass ratio of inorganic particles to the binder is (40-95):(5-60). The inorganic particles include at least one of bochmite, aluminum oxide, barium sulfate, magnesium oxide, magnesium hydroxide, silicon oxide, tin oxide, titanium oxide, calcium oxide, zinc oxide, zirconium oxide, yttrium oxide, nickel oxide, cerium oxide, zirconium titanate, barium titanate, and magnesium fluoride. The binder includes at least one of polyvinylidene fluoride, a vinylidene fluoride-hexafluoropropylene copolymer, polyamide, polyacrylonitrile, an acrylate polymer, polyacrylic acid, polyacrylate, polyvinylpyrrolidone, polyvinyl and ether, polytetrafluoroethylene polyhexafluoropropylene.

In an optional embodiment, the adhesive-coated layer is provided on at least one surface of the base film and/or the ceramic layer. As a preferred embodiment, the adhesive-coated layer is provided on the outer surface of the ceramic layer.

In an optional embodiment, the adhesive-coated layer has a thickness of 0.3 μm to 6 μm. As an example, the thickness of the adhesive-coated layer is 0.3 μm, 1 μm, 1.5 μm, 2 μm, 2.5 μm, 3 μm, 3.5 μm, 4 μm, 4.5 μm, 5 μm, 5.5 μm, 6 μm or in a range of any two of the foregoing values. It should be noted that the thickness of the adhesive-coated layer is the thickness on the same side of the base film layer, i.e. the thickness on one side.

In an optional embodiment, the adhesive-coated layer has a peel force greater than 10 N/m from the base film; The peel force between the adhesive-coated layer and the substrate layer is 11 N/m, 13 N/m, 15 N/m, 17 N/m, 19 N/m, 21 N/m, 23 N/m, 25 N/m or in a range of any two of the foregoing values. It should be understood that the peel strength between the adhesive-coated layer and the base film is higher than that between the ceramic layer and the base film.

In an optional embodiment, the adhesive-coated layer includes a polymer, the polymer is granular and/or non-granular, with the same or different particle sizes. The polymer is a polymer common in the art. For example, the polymer includes copolymers or homopolymers formed from at least one monomer from acrylic acid, methacrylic acid, methyl acrylate, methyl methacrylate, ethyl acrylate, butyl acrylate, ethylhexyl acrylate, styrene, α-methylstyrene, vinyltoluene, ethylene, vinyl acetate, acrylonitrile, vinylidene fluoride, hexafluoropropylene, and chlorophthalic anhydride. The polymer may also be at least one of polyetherimide, polyamideimide, polyimide, and a vinylidene fluoride-hexafluoropropylene copolymer.

In an optional embodiment, the binding strength between the separator and the positive electrode plate is 0-80 N/m; The binding strength cannot be 0. As an example, the binding strength between the separator and the positive electrode plate is 1 N/m, 3 N/m, 8 N/m, 10 N/m, 20 N/m, 30 N/m, 40 N/m, 50 N/m, 60 N/m, 70 N/m, 80 N/m or in a range of any two of the foregoing values.

The binding strength between the separator and the negative electrode plate is 0-80 N/m. The binding strength cannot be 0. As an example, the binding strength between the separator and the negative electrode plate is 1 N/m, 3 N/m, 8 N/m, 10 N/m, 20 N/m, 30 N/m, 40 N/m, 50 N/m, 60 N/m, 70 N/m, 80 N/m or in a range of any two of the foregoing values.

In an optional embodiment, the negative electrode current collector has a tensile strength of not less than 400 MPa in the TD direction; preferably, the negative electrode current collector has a tensile strength of not less than 400 MPa in the MD direction; and/or, the negative electrode current collector has an elongation of not lower than 2% in the TD direction; preferably, the negative electrode current collector has an elongation of not lower than 2% in the MD direction. By way of example, the tensile strength of the negative electrode current collector in the TD direction is 400 MPa, 500 MPa, 600 MPa, 700 MPa, 800 MPa, 900 MPa or in a range of any two of the foregoing values, preferably 700 MPa. The tensile strength of the negative electrode current collector in the MD direction is 400 MPa, 500 MPa, 600 MPa, 700 MPa, 800 MPa, 900 MPa or in a range of any two of the foregoing values, preferably 700 MPa. By way of example, the elongation of the negative electrode current collector in the TD direction is 2%, 3%, 4%, 5%, 6%, 7%, 8%, 9%, 10% or in a range of any two of the foregoing values, preferably not less than 5%. The elongation of the negative electrode current collector in the MD direction is 2%, 3%, 4%, 5%, 6%, 7%, 8%, 9%, 10% or in a range of any two of the foregoing values, preferably not less than 5%.

In an optional embodiment, the negative electrode current collector has an areal density of not less than 26 mg/m². As an example, the areal density of the negative electrode current collector is 26 mg/m², 27 mg/m², 28 mg/m², 29 mg/m², 30 mg/m², 31 mg/m², 32 mg/m², 33 mg/m², 34 mg/m² or in a range of any two of the foregoing values. It can be understood that the areal density of the negative electrode current collector will affect the thickness of the negative electrode current collector. An arcal density of the negative electrode current collector satisfying not less than 26 mg/m² can allow same to have a relatively appropriate thickness. It is well known to those skilled in the art that the negative electrode current collector is a copper foil, a nickel foil, a titanium foil, an iron-nickel alloy foil, etc.

In an optional embodiment, the negative electrode plate includes a negative electrode current collector and a negative electrode active layer provided on at least one surface of the negative electrode current collector, where the negative electrode active layer is of a one-layer or multi-layer structure, and when the negative electrode active layer is of a multi-layer structure, the components of each layer may be the same or different. It can be understood that the components of the negative electrode active layer include active materials, which are common raw materials in the art, e.g., at least one of carbon-based materials, silicon-based materials, tin-based materials, and titanium-based materials; specifically, at least one of artificial graphite, natural graphite, soft carbon, hard carbon, elemental silicon, silicon oxide compounds, silicon carbon composites, silicon-nitrogen composites, silicon alloys, elemental tin, tin oxide compounds, tin alloys, elemental titanium, titanium oxide compounds, and titanium alloys. It should be also understood that the components of the negative electrode active layer may further include an auxiliary agent, such as a conductive agent and a binder. The conductive agent and the binder are of well-known types in the art and are not specifically limited. For example, the conductive agent includes at least one of conductive carbon black, carbon nanotubes, carbon fibers, and Ketjen black; the binder includes at least one of polyacrylic acid, sodium polyacrylate, potassium polyacrylate, lithium polyacrylate, polyimide, polyvinyl alcohol, carboxymethylcellulose, sodium carboxymethylcellulose, polyamideimide, a styrene-butadiene rubber and polyvinylidene fluoride.

In an optional embodiment, at least one surface of the negative electrode current collector is further provided with a second coating. As a preferred embodiment, the second coating is provided between the negative electrode current collector and the negative electrode active layer, the second coating facilitating the deintercalation and intercalation of lithium ions and improving the transport of lithium ions during charge-discharge; the second coating has a thickness of 0.01 μm-3 μm; and the second coating is a carbon coating, which enhances the binding between the active material and the current collector, ensures good contact effect, and reduces or prevents problems such as detachment. As an example, the thickness of the second coating is 0.01 μm, 0.1 μm, 0.5 μm, 1.0 μm, 1.5 μm, 2 μm, 2.5 μm, 3 μm, 3.5 μm, 4 μm, 4.5 μm, 5 μm or in a range of any two of the foregoing values. It should be understood that the thickness of the second coating is the thickness of the coating on the same side of the current collector. It should be noted that the second coating is of a one-layer or multi-layer structure. It is also understood that the components of the second coating include carbon materials and may also include components such as binders.

As a preferred embodiment, the negative electrode plate includes a negative electrode current collector and a second coating provided on both sides of the negative electrode current collector, the negative active layer being provided on the surface of the second coating.

In an optional implementation, the negative electrode current collector contains a doping element. The doping element includes at least one of Cr, Fe, Mg, Mn, Sb, Si, Sn, Ti and Zn. The inclusion of doping elements in the negative electrode current collector facilitates grain refinement, thereby further enhancing tensile strength and elongation.

In an optional embodiment, the content of the doping elements in the negative electrode current collector is not greater than 1000 ppm.

In an optional embodiment, the negative electrode current collector is provided with a groove. The depth of the groove does not exceed the thickness of the negative electrode current collector. The diameter of the groove does not exceed 100 μm. The spacing between adjacent grooves is 0.05 mm-0.5 mm. The negative electrode current collector is provided with grooves to increase the wettability of the electrolyte on the negative electrode, prevent lithium plating on the surface of the negative electrode, avoid lithium dendrites from puncturing the separator, further prevent direct contact between the positive and negative electrode plates that could cause a short circuit in the battery, improve the safety performance of the battery at high temperatures, and enhance the high-temperature cycling performance.

In an optional embodiment, the positive electrode current collector has a tensile strength in the TD direction of not less than 200 MPa; preferably, the tensile strength of the positive electrode current collector in the MD direction is not lower than 200 MPa; and/or, the elongation of the positive electrode current collector in the TD direction is not lower than 2%; preferably, the elongation of the positive electrode current collector in the MD direction is not less than 2%. As an example, the tensile strength of the positive electrode current collector in the TD direction is 200 MPa, 300 MPa, 400 MPa, 500 MPa, 600 MPa, 700 MPa, 800 MPa, 900 MPa or in a range of any two of the foregoing values. The tensile strength of the positive electrode current collector in the MD direction is 200 MPa, 300 MPa, 400 MPa, 500 MPa, 600 MPa, 700 MPa, 800 MPa, 900 MPa or in a range of any two of the foregoing values. As an example, the elongation of the positive electrode current collector in the TD direction is 2%, 3%, 4%, 5%, 6%, 7%, 8%, 9%, 10% or in a range of any two of the foregoing values. The elongation of the positive electrode current collector in the MD direction is 2%, 3%, 4%, 5%, 6%, 7%, 8%, 9%, 10% or in a range of any two of the foregoing values.

In an optional embodiment, the positive electrode current collector has an areal density of not less than 10 mg/m². As an example, the areal density of the positive electrode current collector is 26 mg/m², 27 mg/m², 28 mg/m², 29 mg/m², 30 mg/m², 31 mg/m², 32 mg/m², 33 mg/m², 34 mg/m² or in a range of any two of the foregoing values. It can be understood that the areal density of the positive electrode current collector will affect the thickness of the positive electrode current collector. An arcal density of the positive electrode current collector satisfying not less than 26 mg/m² can allow same to have a relatively appropriate thickness. It is well known to those skilled in the art that the positive electrode current collector is an aluminum foil, etc.

It should be noted that the areal density is measured according to the well-known methods in the art. For example, a small disk of a current collector without any attached substances is die cut using a die cutter having a diameter of 12 mm/16 mm, and weighed, recording the weight m; the area of the die cut small disk is calculated according to the diameter thereof, recording the disk area s; The areal density of the current collector is obtained by m/s. It can also be understood that the areal density of the current collector is the mass per unit area of the current collector.

In an optional implementation, the positive electrode current collector contains a doping element. The doping element includes at least one of Cr, Fe, Mg, Mn, Sb, Si, Sn, Ti and Zn. The content of the doping element of the positive electrode current collector is not more than 1000 ppm. It can be understood that the components of the positive electrode active layer include a positive electrode active material, which is a common raw material in the art, such as at least one or more of lithium nickel oxide, lithium titanate, lithium cobalt oxide, lithium nickel cobalt manganese oxide, lithium nickel cobalt aluminum oxide, lithium iron phosphate, and lithium manganese oxide. The components of the positive electrode active layer also include auxiliary agents, which include binders, conductive agents, etc. The binder includes at least one of polyvinylidene fluoride (PVDF), acrylic acid-modified PVDF, polyacrylate polymers, polyimide, styrene-butadiene rubbers and styrene-acrylic rubbers. The conductive agent includes at least one of conductive carbon black, carbon nanotubes, conductive graphite, and graphene. In the present disclosure the active materials and auxiliary agents are in a ratio common in the art, which is not limited.

In an optional embodiment, the battery also includes an electrolyte. The electrolyte includes an electrolyte salt and a solvent. The electrolyte also includes additives. It should be understood that the electrolyte is a common raw material in the art for preparing batteries.

In an optional embodiment, the electrolyte salt includes at least one of lithium hexafluorophosphate (LiPF₆), lithium tetrafluoroborate (LiBF₄), lithium perchlorate (LiCIO₄), lithium hexafluoroarsenate (LiAsF₆), lithium bisfluorosulfonimide (LiFSI), lithium bis(trifluoromethanesulfonimide) (LiTFSI), lithium trifluoromethanesulfonate (LiTFS), lithium difluorooxalatoborate (LiDFOB), lithium bis(oxalato) borate (LiBOB), lithium difluorophosphate (LiPO₂F₂), lithium bisoxalatodifluorophosphate (LiDFOP), and lithium tetrafluorooxalatophosphate (LiTFOP).

In an optional embodiment, the solvent includes at least one of fluoroethylene carbonate (FEC), ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butylene carbonate (BC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), dimethyl sulfone (MSM), methyl ethyl sulfone (EMS) and diethyl sulfone (ESE).

In an optional embodiment, the additive includes a negative electrode surface film-forming additive, a positive electrode surface film-forming additive, and a positive and negative electrode current collector surface film-forming additive; and can also include an additive capable of improving certain performances of the battery, such as an additive capable of improving the overcharge performance of the battery, and an additive capable of improving the high- or low-temperature performance of the battery. The additive may be a nitrile compound such as a dinitrile compound and a trinitrile compound, a cyclic carbonate containing a carbon-carbon double bond, a fluorinated chain carbonate, a fluorinated cyclic carbonate or a sulfur-oxygen double bond-containing compound, and the following compounds are listed here:

The dinitrile compound includes, but is not limited to: succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylvaleronitrile, 2,2,4,4-tetramethylglutaronitrile, 1,5-dicyanopentane, 2,6-dicyanoheptane, 2,7-dicyanooctane, 2,8-dicyanononane, 1,6-dicyanodecane, 1,2-dicyanobenzene, 1,3-dicyanobenzene, 1,4-dicyanobenzene, 3,5-dioxa-heptanenitrile, 1,4-bis(cyanoethoxy) butane, ethylene glycol bis(2-cyanoethyl) ether, diethylene glycol bis(2-cyanoethyl) ether, triethylene glycol bis(2-cyanoethyl) ether, tetraethylene glycol bis(2-cyanoethyl) ether, 3,6,9,12,15,18-hexaoxacicosanedinitrile, 1,3-bis(2-cyanoethoxy) propane, 1,4-bis(2-cyanoethoxy) butane, 1,5-bis(2-cyanoethoxy)pentane, ethylene glycol bis(4-cyanobutyl) ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene or 1,6-dicyano-2-methyl-5-methyl-3-hexene.

The trinitrile compound includes, but is not limited to: 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy)propane, 1,2,4-tris(2-cyanoethoxy)butane, 1,1,1-tris(cyanoethoxymethylene)ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane or 1,2,5-tris(cyanoethoxy)pentane.

The cyclic carbonate containing a carbon-carbon double bond includes, but is not limited to: vinylene carbonate, methylvinylene carbonate, ethylvinylene carbonate, 1,2-dimethylvinylene carbonate, 1,2-diethylvinylene carbonate, fluorovinylene carbonate, trifluoromethylvinylene carbonate; vinyl ethylene carbonate, 1-methyl-2-vinylethylene carbonate, 1-ethyl-2-vinylethylene carbonate, 1-n-propyl-2-vinylethylene carbonate, 1-methyl-2-vinylethylene carbonate, 1,1-divinylethylene carbonate, 1,2-divinylethylene carbonate; 1,1-dimethyl-2-methyleneethylene carbonate, and 1,1-diethyl-2-methyleneethylene carbonate.

The fluorinated chain carbonate includes, but is not limited to: fluoromethyl methyl carbonate, difluoromethyl methyl carbonate, trifluoromethyl methyl carbonate, trifluoroethyl methyl carbonate or bis(trifluoroethyl)carbonate.

The fluorinated cyclic carbonate includes, but is not limited to: fluoroethylene carbonate, 4,4-difluoroethylene carbonate, 4,5-difluoroethylene carbonate, 4-fluoro-4-methylethylene carbonate, 4,5-difluoro-4-methylethylene carbonate, 4-fluoro-5-methylethylene carbonate, 4,4-difluoro-5-methylethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoroethylene carbonate, 4-(fluoromethyl)-5-fluoroethylene carbonate, 4-fluoro-4,5-dimethylethylene carbonate, 4,5-difluoro-4,5-dimethylethylene carbonate, and 4,4-difluoro-5,5-dimethylethylene carbonate.

The sulfur-oxygen double bond-containing compound includes, but is not limited to: cyclic sulfates, chain sulfates, chain sulfonates, cyclic sulfonates, chain sulfites, cyclic sulfites, chain sulfones, cyclic sulfones, etc.

In an optional embodiment, the electrolyte includes a lithium salt, an organic solvent, an additive A and an additive B, where the additive A is a dinitrile compound containing a carbon-carbon double bond, and additive B is a silyl phosphate compound and/or silyl borate compound. The content of the dinitrile compound containing a carbon-carbon double bond is 0.5 to 10% of the total weight of the electrolyte. The content of the additive B is 0.5 to 10% of the total weight of the electrolyte. Further preferably, the total content of the silyl phosphate compound and the silyl borate compound is 1 to 5% of the total weight of the electrolyte.

In an optional embodiment, that electrolyte includes an organic solvent, a lithium salt, and an additive. The additive includes a cyclic phosphoric anhydride compound and a dinitrile compound containing unsaturated bonds. The cyclic phosphoric anhydride compound has a mass content percentage of 0.1 to 3% in the non-aqueous electrolyte. The dinitrile compound containing unsaturated bonds has a mass content percentage of 0.1% to 4% in the non-aqueous electrolyte.

In an optional embodiment, that electrolyte includes a lithium salt, an organic solvent, and an additive. The additive includes a cyclic sulfate, a fluorocarbon surfactant, and a dinitrile compound containing carbon-carbon double bonds. The content of the cyclic sulfate is 1% to 5% of the total weight of the electrolyte. The content of the fluorocarbon surfactant is 0.05% to 0.1% of the total weight of the electrolyte. The content of the dinitrile compound containing carbon-carbon double bonds is 1% to 5% of the total weight of the electrolyte.

In an optional embodiment, the electrolyte includes a lithium salt, an organic solvent, and an additive. The organic solvent includes a carboxylate ester compound. The additive includes a dinitrile compound containing carbon-carbon double bonds and a silyl sulfate compound. The content of the dinitrile compound containing carbon-carbon double bonds is 0.5% to 10% of the total weight of the electrolyte. The content of the silyl sulfate compound is 0.5% to 10% of the total weight of the electrolyte. The volume of the carboxylate ester compound is 5% to 50% of the total volume of the organic solvent, preferably 10% to 40%, and further preferably 20% to 35%.

It should be noted that during use, one or more auxiliary agents can be selected, depending on the requirements of the use.

### Example 1

This example provided a battery, including:

### (1) Positive Electrode Plate

TiO₂ and PVDF were mixed at a mass ratio of 95:5, NMP was added, the mixture was stirred to obtain a first coating slurry having a solids content of 40%, which was applied on both surfaces of an aluminum foil and dried to obtain a first coating. The TiO₂ was coated with ATO, the content of ATO in the ATO-coated TiO₂ being 10 wt %, and the average particle size being 0.4 μm. The puncture force C and thickness D of the aluminum foil were shown in Table 1.

Lithium cobalt oxide, conductive carbon black, and polyvinylidene fluoride (PVDF) were added into a stirring tank at a mass ratio of 97.2:1.5:1.3, then an NMP solution was added, and the mixture was fully stirred to prepare a uniform positive electrode active slurry. The slurry was applied on the surface of the first coating and dried, followed by rolling to obtain a positive electrode plate coated with the first coating and the active layer. The single-sided thickness M of the first coating on the positive electrode plate after rolling, the area resistance K of the coating layer, and the thickness H of the positive electrode plate were shown in Table 1.

### (2) Negative Electrode Plate

Graphite, Super-P and sodium carboxymethyl cellulose were added to the stirring tank at a mass ratio of 97:1.5:1.5, then deionized water was added and the mixture was fully stirred to obtain a uniform negative electrode active slurry. The negative electrode active slurry was respectively applied on both surfaces of the negative electrode current collector (a copper foil), and then dried to remove moisture, followed by sequentially rolling, slitting and plate-making processes to obtain the desired negative electrode plate. The thickness F of the negative electrode current collector, the puncture force E, and the thickness I of the negative electrode plate were shown in Table 1.

### (3) Electrolyte

In a glove box filled with argon gas and with acceptable water and oxygen contents, ethylene carbonate, propylene carbonate, propyl propionate and ethyl propionate were mixed uniformly at a mass ratio of 1:2:5:2. Then, fully dried lithium hexafluorophosphate (LiPF₆) was quickly added and stirred uniformly, and after passing the moisture and free acid tests, the desired electrolyte was obtained. The content of LiPF₆ in the electrolyte was 15 wt %.

### (4) Separator

The separator included a base film, a ceramic layer and an adhesive-coated layer which are stacked in sequence, the ceramic layer being provided on both sides of the base film, and the adhesive-coated layer being provided on a surface of the ceramic layer. 5 μm thick polyethylene (PE) was used as the base film, and the ceramic layer and the adhesive-coated layer have a total thickness of 4 μm. The ceramic layer included inorganic particles and a binder, where the inorganic particles were aluminum oxide particles and the binder is polyacrylate. The adhesive-coated layer includes polyvinylidene fluoride. The thickness B of the base film of PE film was shown in Table 1, and the puncture force A of the separator, thickness N, deformation G and ionic conductivity J were shown in Table 1.

### (5) Lithium-Ion Battery

The positive electrode plate, the separator and the negative electrode plate were sequentially wound into a bare wound core, the bare cell described above are placed in an outer packaging foil, followed by top sealing and side sealing, baking to remove moisture. The electrolyte is injected, followed by procedures of vacuum packaging, leaving to stand, formation and shaping, so as to obtain a lithium-ion battery.

### Example 2-20

Examples 2-20 provided a lithium-ion battery, differing from Example 1 in that the thickness B of the base film, the puncture force C of the positive electrode current collector, the thickness D of the positive electrode current collector, the puncture force E of the negative electrode current collector, the thickness F of the negative electrode current collector, L₁, the deformation G generated during the puncture force test of the separator, the thickness H of the positive electrode plate, the thickness I of the negative electrode plate, the ionic conductivity J of the separator, the area resistance K of the first coating, the thickness M of the first coating and the thickness N of the separator were different. The specific parameters were shown in Table 1.

### Comparative Example 1-3

Comparative Examples 1-3 provided a lithium-ion battery, differing from Example 1 in that the thickness B of the base film, the puncture force C of the positive electrode current collector, the thickness D of the positive electrode current collector, the puncture force E of the negative electrode current collector, the thickness F of the negative electrode current collector, L₁, the deformation G generated during the puncture force test of the separator, the thickness H of the positive electrode plate, the thickness I of the negative electrode plate, the ionic conductivity J of the separator, the area resistance K of the first coating, the thickness M of the first coating and the thickness N of the separator were different. The specific parameters were shown in Table 1.

### Test Examples

This test example provided the performance of the batteries of the Examples and Comparative Examples, as follows:
(1) Test method for puncture force of separator and current collector: the material to be tested was cut into 10 cm×10 cm samples, the sample was secured in the ring-shaped fixture below the universal tensile machine, the needle was fixed on the upper fixture, and the needle is moved down at a speed of 100 mm/min during testing, where the maximum force applied to the needle during puncture of the sample to be tested was the puncture force. The deformation G is L₂=\sqrt{L₁²+R²} calculated using G=L₂−R.
(2) Test method for area resistance of coating: the area resistance was tested using a bulk resistor meter.

The test method for the ionic conductivity of the separator: the test is carried out using an ionic conductivity tester. Specifically, the separator was cut into a circular sample with a diameter of 4 cm, the sample was immersed in the electrolyte for 2 h, then 1, 2, 3, 4, or 5 layers of separators were placed between the upper/lower electrodes of the ion conductivity tester respectively, with each layer tested once, in a total number of 5 times, which clamped the separators, and the resistance values R₁, R₂, R₃, R₄ and R₅ were measured. With the number of separator layers as the abscissa and the separator resistance as the ordinate, the slope k of the curve is calculated, and the ionic conductivity o of the separator is calculated by substituting the value into the following formula. When the linear fitting degree of the curve is greater than 0.99, it is calculated according to the following formula. When the linear fitting degree is less than 0.99, recalculation is required.

$$R = k \times 1$$

$$σ = \frac{d}{R \times S}$$

where R is the resistance value of a 1-layer separator in 22; k is the slope of the curve when the linear fitting degree is greater than 0.99; d is the thickness of a 1-layer separator in μm; S is the area of the separator in cm².
(3) Test method for low-temperature cycling performance: the battery was placed in a low-temperature test chamber at (0±2° C.) and charged at a constant current to 4.4 V (cut-off current of 0.05 C) at a current density of 1.2 C, the battery was fully charged and left to stand for 5 min, then discharged at a constant current at a current density of 0.5 C (cut-off voltage 3.0 V), the discharge capacity was recorded as the initial capacity Q₁, when the cycle reached 200 cycles, the last discharge capacity Q₂ of the battery was recorded. The capacity retention was calculated using the formula below, with results shown in Table 2.

$$Capacity retention ( \% ) = \frac{{Q}_{2}}{{Q}_{1}} \times 100 \%$$

(4) Test method for nail penetration pass rate: the lithium-ion battery was fully charged and then placed on the test bench of the nail penetration test apparatus, and a tungsten steel needle having a diameter of 3 mm and a nail tip length of 3.62 mm was moved to penetrate the battery at the center at a speed of 100 mm/s. If the battery did not ignite or explode, it is considered as passing the test, with a number of 50 tests per example. The nail penetration pass rate was calculated according to the following formula:

nail penetration pass rate=number of pass/number of tests.
(5) Test method for drop-weight impact pass rate: the battery was fully charged at ambient temperature of (25±2° C.), the cell was placed on a plane, and a steel column with a diameter of 15.8±0.2 mm was placed at the center of the cell such that the longitudinal axis of the steel column is parallel to the plane, a heavy object with a mass of 9.1±0.1 kg was freely dropped from a height of 610±25 mm onto the steel column above the center of the battery, after the test was completed, if the battery did not ignite or explode or emit smoke, it was recorded as passing. The number of tests per example is 50. The pass rate of the drop-weight impact is calculated according to the following formula.

The pass rate of drop-weight impact=the number of passes/the number of tests.

TABLE 1
Parameters examples

| | A/ | B/ | C/ | D/ | E/ | F/ | L₁/ | G/ | H/ | I/ | J/ | K/ | M/ | N/ |
|---|---|---|---|---|---|---|---|---|---|---|---|---|---|---|
| Example | N | μm | N | μm | N | μm | mm | mm | μm | μm | mS/cm | mΩ | μm | μm |
| Example 1 | 2 | 5 | 1.2 | 8 | 1.2 | 6 | 2 | 0.2 | 80 | 80 | 0.8 | 20 | 0.5 | 9 |
| Example 2 | 4 | 5 | 1.2 | 8 | 1.2 | 6 | 1.9 | 0.18 | 80 | 80 | 0.8 | 20 | 0.5 | 9 |
| Example 3 | 6 | 5 | 1.2 | 8 | 1.2 | 6 | 1.8 | 0.16 | 80 | 80 | 0.8 | 20 | 0.5 | 9 |
| Example 4 | 4 | 5 | 1 | 8 | 1.2 | 6 | 1.9 | 0.18 | 80 | 80 | 0.8 | 20 | 0.5 | 9 |
| Example 5 | 4 | 5 | 2.5 | 8 | 1.2 | 6 | 1.9 | 0.18 | 80 | 80 | 0.8 | 20 | 0.5 | 9 |
| Example 6 | 4 | 5 | 1.2 | 8 | 0.5 | 6 | 1.9 | 0.18 | 80 | 80 | 0.8 | 20 | 0.5 | 9 |
| Example 7 | 4 | 5 | 1.2 | 8 | 2.5 | 6 | 1.9 | 0.18 | 80 | 80 | 0.8 | 20 | 0.5 | 9 |
| Example 8 | 4 | 5 | 1.2 | 8 | 1.2 | 6 | 1.9 | 0.18 | 80 | 80 | 0.4 | 20 | 0.5 | 9 |
| Example 9 | 4 | 5 | 1.2 | 8 | 1.2 | 6 | 1.9 | 0.18 | 80 | 80 | 1.6 | 20 | 0.5 | 9 |
| Example 10 | 2 | 5 | 1.2 | 8 | 1.2 | 6 | 2 | 0.2 | 80 | 80 | 0.8 | 55 | 0.5 | 9 |
| Example 11 | 2 | 5 | 1.2 | 8 | 1.2 | 6 | 2 | 0.2 | 80 | 80 | 0.8 | 95 | 0.5 | 9 |
| Example 12 | 4 | 5 | 1.2 | 8 | 1.2 | 6 | 1.9 | 0.18 | 80 | 80 | 0.8 | 20 | 3 | 9 |
| Example 13 | 4 | 5 | 1.2 | 8 | 1.2 | 6 | 1.9 | 0.18 | 80 | 80 | 0.8 | 20 | 4.8 | 9 |
| Example 14 | 3 | 3 | 1.2 | 8 | 1.2 | 6 | 1.9 | 0.18 | 80 | 80 | 0.8 | 20 | 0.5 | 7 |
| Example 15 | 3 | 7 | 1.2 | 8 | 1.2 | 6 | 1.9 | 0.18 | 80 | 80 | 0.8 | 20 | 0.5 | 11 |
| Example 16 | 2 | 5 | 1.2 | 8 | 1.2 | 6 | 1.5 | 0.1 | 80 | 80 | 0.9 | 15 | 0.5 | 9 |
| Example 17 | 3 | 5 | 1.3 | 8 | 1 | 6 | 1.8 | 0.16 | 80 | 80 | 0.8 | 20 | 0.5 | 9 |
| Example 18 | 2 | 5 | 1.2 | 8 | 1.2 | 6 | 1.5 | 0.1 | 110 | 110 | 0.8 | 20 | 0.5 | 9 |
| Example 19 | 2 | 5 | 1.2 | 8 | 1.2 | 6 | 2 | 0.2 | 80 | 80 | 0.4 | 90 | 0.5 | 9 |
| Example 20 | 2 | 5 | 1.2 | 8 | 1.2 | 8 | 2 | 0.2 | 80 | 80 | 0.8 | 20 | 0.5 | 7 |
| Comparative | 0.9 | 3 | 0.4 | 8 | 0.4 | 6 | 2 | 0.2 | 80 | 80 | 0.8 | 20 | 0.5 | 9 |
| example 1 | | | | | | | | | | | | | | |
| Comparative | 1.5 | 4 | 1.5 | 8 | 1.7 | 6 | 2 | 0.2 | 80 | 80 | 0.8 | 20 | 0.5 | 9 |
| example 2 | | | | | | | | | | | | | | |
| Comparative | 0.9 | 4 | 0.8 | 8 | 0.8 | 5 | 2 | 0.2 | 80 | 80 | 0.8 | 20 | 0.5 | 9 |
| example 3 | | | | | | | | | | | | | | |

TABLE 2
Testing results of Examples

| | Capacity | Nail penetration | Drop-weight |
|---|---|---|---|
| Example | retention (%) | pass rate | impact pass rate |
| Example 1 | 97.90% | 44/50pass | 45/50pass |
| Example 2 | 97.90% | 48/50pass | 47/50pass |
| Example 3 | 97.90% | 50/50pass | 49/50pass |
| Example 4 | 97.90% | 48/50pass | 48/50pass |
| Example 5 | 97.90% | 47/50pass | 48/50pass |
| Example 6 | 97.90% | 48/50pass | 49/50pass |
| Example 7 | 97.90% | 48/50pass | 49/50pass |
| Example 8 | 95.90% | 48/50pass | 48/50pass |
| Example 9 | 97.90% | 48/50pass | 48/50pass |
| Example 10 | 95.60% | 46/50pass | 46/50pass |
| Example 11 | 95.30% | 46/50pass | 47/50pass |
| Example 12 | 97.90% | 48/50pass | 48/50pass |
| Example 13 | 97.90% | 49/50pass | 48/50pass |
| Example 14 | 97.90% | 47/50pass | 46/50pass |
| Example 15 | 97.90% | 49/50pass | 48/50pass |
| Example 16 | 97.80% | 46/50pass | 45/50pass |
| Example 17 | 97.90% | 45/50pass | 46/50pass |
| Example 18 | 97.90% | 43/50pass | 43/50pass |
| Example 19 | 94.20% | 46/50pass | 47/50pass |
| Example 20 | 97.90% | 43/50pass | 42/50pass |
| Comparative | 96.10% | 37/50pass | 37/50pass |
| example 1 | | | |
| Comparative | 95.80% | 36/50pass | 37/50pass |
| example 2 | | | |
| Comparative | 95.50% | 30/50pass | 29/50pass |
| example 3 | | | |

It can be seen from the above results that according to the present disclosure, the puncture force of the separator, the thickness of the base film, the puncture force of the positive electrode current collector, the thickness of the positive electrode current collector, the puncture force of the negative electrode current collector, and the thickness of the negative electrode current collector satisfy relationship 1, and the puncture force A is 1 N-8 N, and the thickness B of the base film is 3 μm-16 μm, the puncture force C of the positive electrode current collector is 1 N-10 N, the thickness D of the positive electrode current collector is 5 μm-20 μm, the puncture force E of the negative electrode current collector is 1 N-10 N, and the thickness F of the negative electrode current collector is 3 μm-20 μm, such that the contact of the current collector with the active material under mechanical abuse can be reduced, thereby reducing the short-circuit point formation and heat generation, lowing the probability of thermal runaway, and improving the mechanical abuse test pass rate, for example, the nail penetration pass rate and drop-weight impact pass rate are high. Problems such as a low battery mechanical abuse test pass rate can occur when the above conditions are not met.

In combination with Examples 18-20, the deformation G generated during the puncture force test of the separator of the present disclosure and the thickness H of the positive electrode sheet satisfy relationship 2 or the deformation G generated during the puncture force test of the separator and the thickness I of the negative electrode plate satisfy relationship 3, which can further improve the mechanical abuse test pass rate. The ionic conductivity J of the separator and the area resistance K of the first coating satisfy relationship 4, which can further improve the safety and electrical performance of the battery. The thickness M of the first coating, the thickness N of the separator and the thickness F of the negative electrode current collector satisfy relationship 6, which can further improve the battery mechanical abuse test pass rate.

Obviously, the above examples are merely examples given for clarity of illustration and are not intended to limit the embodiments. For those of ordinary skill in the art, other different forms of changes or variations could have also been made on the basis of the above-mentioned illustrations. There is no need to exhaustively list all embodiments herein, although it cannot be achieved. The obvious changes or variations thus derived are still within the scope of protection of the disclosure.

What is claimed is:

1. A lithium-ion battery, comprising a positive electrode plate, a negative electrode plate and a separator provided between the positive electrode plate and the negative electrode plate,
wherein the positive electrode plate comprises a positive electrode current collector and a positive electrode active layer on a surface of at least one side of the positive electrode current collector;
the negative electrode plate comprises a negative electrode current collector and a negative electrode active layer on a surface of at least one side of the negative electrode current collector;
the separator comprises a base film; and
a puncture force A of the separator, a thickness B of the base film, a puncture force C of the positive electrode current collector, a thickness D of the positive electrode current collector, a puncture force E of the negative electrode current collector and a thickness F of the negative electrode current collector satisfy relationship 1:
$$\frac{A}{B} > \frac{C}{D} + \frac{E}{F} \qquad relationship 1$$
wherein, A ranges from 1 N to 8 N; B ranges from 3 μm to 16 μm; C ranges from 1 N to 10 N; D ranges from 5 μm to 20 μm; E ranges from 1 N to 10 N; and F ranges from 3 μm to 20 μm.

2. The lithium-ion battery according to claim 1, wherein C ranges from 1 N to 2.5 N; and/or, E ranges from 1 N to 2.5 N.

3. The lithium-ion battery according to claim 1, wherein a deformation G generated during testing the puncture force of the separator and a thickness H of the positive electrode plate satisfy relationship 2;
$$G > H \qquad relationship 2$$
wherein G=L₂−R, and
$${L}_{2} = \sqrt{{{L}_{1}}^{2} + {R}^{2}} ,$$
L₁ is a displacement traveled by a needle when the separator is punctured during puncturing, L₁ ranges from 1.5 mm to 4.5 mm, R is a distance from a point at which the needle initially contacts the separator to an edge of a fixture; and
H ranges from 50 μm to 150 μm.

4. The lithium-ion battery according to claim 3, wherein H ranges from 60 μm to 110 μm.

5. The lithium-ion battery according to claim 1, wherein a deformation G generated during testing the puncture force of the separator and a thickness I of the negative electrode plate satisfy relationship 3:
$$G > I \qquad relationship 3$$
wherein G=L₂−R, and
$${L}_{2} = \sqrt{{{L}_{1}}^{2} + {R}^{2}} ,$$
L₁ is a displacement traveled by a needle when the separator is punctured during puncturing, L₁ ranges from 1.5 mm to 4.5 mm, R is a distance from a point at which the needle initially contacts the separator to an edge of a fixture; and I ranges from 50 μm to 180 μm.

6. The lithium-ion battery according to claim 5, wherein I ranges from 50 μm to 100 μm.

7. The lithium-ion battery according to claim 1, wherein the positive electrode current collector is provided with a first coating on at least one surface, the first coating is provided between the positive electrode current collector and the positive electrode active layer, the first coating has an area resistance of 1 mΩ to 1000 mΩ.

8. The lithium-ion battery according to claim 7, wherein the first coating has an area resistance of 1 mΩ to 100 mΩ.

9. The lithium-ion battery according to claim 7, wherein the first coating comprises a non-conductive organic polymer.

10. The lithium-ion battery according to claim 9, wherein the non-conductive organic polymer is present as polymer particles.

11. The lithium-ion battery according to claim 7, wherein an ionic conductivity J of the separator and an area resistance K of the first coating satisfy relationship 4:
$$0.5 \% \leq \frac{J}{K} \times 100 \% \leq 10 \% \qquad relationship 4$$
wherein J ranges from 0.1 to 5 mS/cm; and K ranges from 1 mΩ to 100 mΩ.

12. The lithium-ion battery according to claim 11, wherein the ionic conductivity J of the separator and the area resistance K of the first coating satisfy relationship 5:
$$4 \% \leq \frac{J}{K} \times 100 \% \leq 6 \% . \qquad relationship 5$$

13. The lithium-ion battery according to claim 7, wherein a thickness M of the first coating, a thickness N of the separator and the thickness F of the negative electrode current collector satisfy relationship 6:
$$\frac{M + N}{F} > 1 \qquad relationship 6$$
wherein M ranges from 0.1 μm to 5 μm; and N ranges from 3 μm to 22 μm.

14. The lithium-ion battery according to claim 7, wherein the first coating further comprises an inorganic filler, the inorganic filler is coated with a conductive layer, and the inorganic filler coated with the conductive layer, the binder and the conductive agent have a mass ratio of (60-98):(2-40):(0-5).

15. The lithium-ion battery according to claim 1, wherein the positive electrode current collector contains a doping element, and the doping element comprises at least one of Cr, Fe, Mg, Mn, Sb, Si, Sn, Ti or Zn.

16. The lithium-ion battery according to claim 1, wherein at least one surface of the negative electrode current collector is further provided with a second coating, the second coating is provided between the negative electrode current collector and the negative electrode active layer, the second coating has a thickness of 0.01 μm-3 μm; and the second coating is a carbon coating.

17. The lithium-ion battery according to claim 1, wherein the negative electrode current collector comprises a doping element, and the doping element comprises at least one of Cr, Fe, Mg, Mn, Sb, Si, Sn, Ti and Zn; and/or,
the negative electrode current collector is provided with a groove, a depth of the groove does not exceed the thickness of the negative electrode current collector, a diameter of the groove does not exceed 100 μm, and a spacing between adjacent grooves ranges from 0.05 mm to 0.5 mm.

18. The lithium-ion battery according to claim 1, wherein a tensile strength of the separator in a transverse direction (TD direction) ranges from 1200 kgf/cm² to 7000 kgf/cm², and a tensile strength of the separator in a machine direction (MD direction) ranges from 1200 kgf/cm² to 7000 kgf/cm²; and/or,
an elongation at break of the separator in the TD direction is greater than 30%, and an elongation at break of the separator in the MD direction is greater than 30%; and/or,
a puncture strength of the separator is greater than 120 gf.

19. The lithium-ion battery according to claim 1, wherein the base film has a thickness of 3 μm-16 μm; and/or, the base film has an air permeability of 50 s/100 cc-250 s/100 cc; and/or, the base film has a porosity of 25-50%; and/or, the base film has a pore size distribution of 20 nm-90 nm.

20. The lithium-ion battery according to claim 1, wherein the separator further comprises an adhesive-coated layer and a ceramic layer, the ceramic layer is provided at least on one surface of the base film, a thickness of the ceramic layer ranges from 0.3 μm to 4 μm, and the adhesive-coated layer is provided on at least one surface of the base film and/or the ceramic layer.
